(19) United States
(12) Patent Application Publication
(10) Pub. No.: US 2010/0036771 A1
(43) Pub. Date: Feb. 11, 2010

(54) System, method an computer program product for processing automated clearing house (ACH) historical data

(75) Inventors: Carl P. Daniel, El Dorado Hills, CA (US); Ben K. Waidhofer, Folsom, CA (US)

Correspondence Address: VENABLE LLP, P.O. BOX 34385, WASHINGTON, DC, 20043-9998, US

(73) Assignee: Laru Corporation, Folsom, CA (US)

(21) Appl. No.: 12/222,536

(22) Filed: Aug. 11, 2008

(51) Int. Cl. G06Q 10/00; H04L 9/00; G06Q 50/00

(52) U.S. Cl. 705/50; 705/30; 705/7

(57) ABSTRACT

A system, method, and computer program product for processing automated clearing house (ACH) historical data is provided. The system includes a storage device, a processor, a reconciler component, a risk management component, a pattern matching component, a distribution component, and a display device. The storage device stores ACH historical data from depository financial institutions (DFI) and an ACH operator. The reconciler component identifies related ACH transactions. The risk management component calculates and displays return exposure. The pattern matching component detects rules violations and sends alerts to the DFIs. The distribution component generates and displays a time distribution of ACH returns.

### BACKGROUND OF THE INVENTION

1. Field of the Invention

The present application relates generally to Automated Clearing House (ACH) transactions, auditing, risk management, data warehousing, and online analytical processing (OLAP) and more particularly to a system, method, and computer program product for processing ACH historical data.

2. Related Art

The Automated Clearing House (ACH) is an electronic payment network used by individuals, businesses, financial institutions, government organizations, ant others to issue and receive payments. ACH payments provide better cash management capabilities and a lower cost per transaction than traditional paper payments (e.g., checks) and credit cards. The ACH network exchanges funds and information throughout the fifty states as well as U.S. territories, and Canada. Nearly all of the nation's financial institutions, including banks, savings banks, and credit unions participate in or transact across the ACH network.

### SUMMARY OF THE INVENTION

Exemplary embodiments include capturing ACH historical data from a depository financial institution's (DFI's) native file system at various time intervals, capturing DFI data from the ACH operator; storing and forwarding ACH historical data to a concerned DFI at various time intervals; a method to analyze the ACH historical data by using logic- and rule-based techniques; a method to secure the privacy of data captured; a method to manipulate the data using data warehouses and OLAP cubes. As a result of these analyses, DFIs will discover federally mandated network violations and report them in a less laborious manner through process automation and DFIs will discover irregular item return activity. Exemplary embodiments further include a method to display the results of the analysis by using reports in columnar and graphical representation.

Exemplary embodiments include a method for processing that visualizes ACH data over many slices using an OLAP database.

Exemplary embodiments include a method for processing that calculates return exposure using weighted return rates, which may be weighted based on previous origination or return aging.

Exemplary embodiments include a method for processing that visualizes the basis for exposure as a two-dimensional gray-scale plot where the x-axis it the time into the future and the y-axis is the origination files.

Exemplary embodiments include a method for processing that identifies related entries using hashed surrogate keys that are derived from item attributes, partitioned by time, and/or partitioned by value.

Exemplary embodiments include a method for processing that identifies protocol violations where potential violations are described by a database of patterns, where traffic is described by a tokenized language, and/or where violations are detected by comparing token sentences to the database of potential violation patterns.

Exemplary embodiments include a method for processing that automates the handling of exceptions, where the handling follows a new/open/close workflow, where the exceptions being handled are network rules violations, and/or the exceptions being handled are potential risk events.

Exemplary embodiments include a method for processing ACH historical data with a system that includes one or more processors, one or more storage devices coupled to the processor, a reconciler component that runs on the processor, a risk management component that runs on the processor and a display device coupled to the processor. The storage device stores ACH historical data, which comprises ACH data from at least one DFI and ACH data from at least one ACH operator. The reconciler component identifies two or more related ACH transactions in the ACH historical data., the risk management component calculates an ACH return exposure, and the display device displays the ACH return exposure.

In exemplary embodiments, the ACH historical data may be captured from a DFI's native file system at various time intervals and/or captured from the ACH operator and store and forward to a concerned DFI at various time intervals. The ACH return exposure may be performed by using logic- and rule-based techniques. The privacy of the ACH historical data may be secured by the system. The system may include one or more data warehouses and one or more OLAP cubes. The system may discover and report rule violations and may discover irregular item return activity. The ACH return exposure display may include one or more reports in columnar and graphical representations. The ACH return exposure may use weighted return rates that may be based on previous originations and/or return aging. The ACH return exposure display may include a visualization of a basis for the ACH return exposure. The visualization may include a two-dimensional gray-scale plot, where one of the two dimensions may be an x-axis representing future time and the other may be a y-axis representing origination files. The reconciler component may identify related ACH transactions in the ACH historical data by using a plurality of hashed surrogate keys that may be derived from item attributes. The ACH transactions may be partitioned by time and/or by value. The system may identify one or more exceptions, including one or more rules violations and one or more potential risk events. One or more potential rules violations may be described by one or more databases that store patterns. The rules violations may be detected by comparing a plurality of token sentences to the database of potential rules violation patterns. The exceptions may be reported by following a new, open, or closed workflow.

Exemplary embodiments include a method for processing ACH historical data by a system including one or more processors coupled to one or more storage devices and a pattern matching component, reconciler component, and one or more messaging systems that execute on the processor. The storage device stores ACH historical data that includes ACH data from one or more DFI and ACH data from one or more ACH operator. The reconciler component identifies two or more related ACH transactions in the ACH historical data, the pattern matching component detects one or more ACH rules violations, and the messaging system provides one or more alerts for the detected ACH rules violation. Exemplary embodiments include a computer program product stored on a storage medium, the computer program product comprising instructions for performing this method.

Further features and advantages of the invention, as well as the structure and operation of various exemplary embodiments of the invention, are described in detail below with reference to the accompanying drawings.

### BRIEF DESCRIPTION OF THE DRAWINGS

The foregoing and other features and advantages of the invention will be apparent from the following, more particular description of various exemplary embodiments including a preferred embodiment of the invention, as illustrated in the accompanying drawings wherein like reference numbers generally indicate identical, functionally similar, and/or structurally similar elements. The left most digits in the corresponding reference number indicate the drawing in which an element first appears.

FIG. 1 illustrates ACH credit clearing and settlement for a typical credit transaction;

FIG. 2 illustrates ACH debit clearing and settlement for a typical debit transaction;

FIG. 3 illustrates a typical Internet-initiated (WEB) ACH transaction for a consumer paying a bill to a gas company;

FIG. 4 is a block diagram of an exemplary embodiment of a system for processing ACH historical data;

FIG. 5 is a flowchart of an exemplary method for processing ACH historical data;

FIG. 6 is a block diagram of an exemplary embodiment of a system for processing ACH historical data by a provider for a customer;

FIG. 7 is a flowchart of an exemplary embodiment of a method of processing ACH historical data with the system of FIG. 6;

FIG. 8 is a flowchart of an exemplary method of calculating an ACH return exposure;

FIG. 9 is a flowchart of an exemplary method of calculating return rate;

FIG. 10 is a flowchart of an exemplary method 1000 of calculating return share;

FIG. 11 is a flowchart of an exemplary method of identifying related ACH transactions (reconciliation);

FIG. 12 is an exemplary embodiment of a chart showing time distribution of ACH returns by origination file or date;

FIG. 13 is a flowchart of an exemplary method for creating the return age by file chart of FIG. 12;

FIG. 14 is a flowchart of an exemplary method for handling rules violations;

FIG. 15 is a diagram illustrating an exemplary computer system such as may be used in devices that may be used in implementing an exemplary embodiment of the present invention; and

FIGS. 16A, 16B, 16C, 16D, and 16E illustrate some sample reports.

### DETAILED DESCRIPTION OF VARIOUS EXEMPLARY EMBODIMENTS OF THE PRESENT INVENTION

Various exemplary embodiments of the invention including preferred embodiments are discussed in detail below. While specific exemplary embodiments are discussed, it should be understood that this is done for illustration purposes only. A person skilled in the relevant art will recognize that other components and configurations can be used without parting from the spirit and scope of the invention.

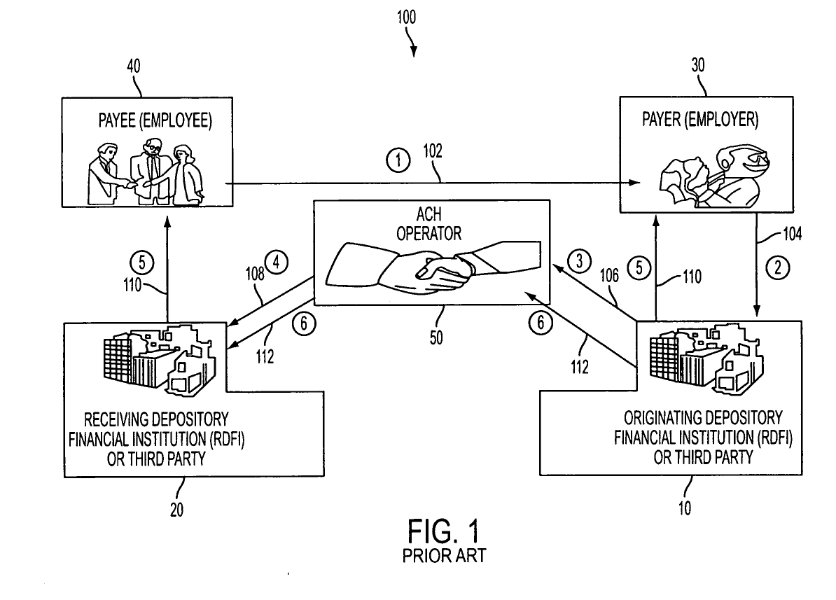

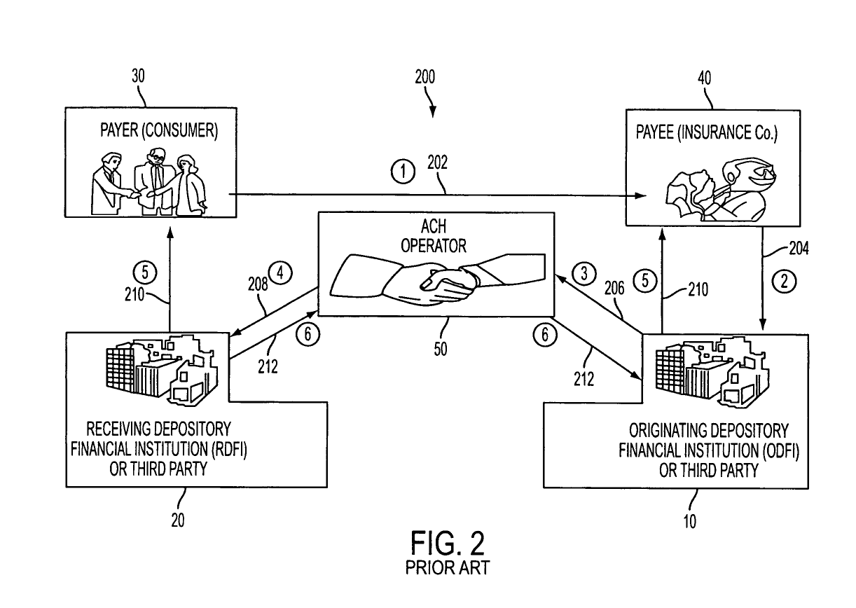

As shown in FIGS. 1 and 2, in a typical ACH transaction, instructions flow from an originating depository financial institution (ODFI) (or third party) 10 to a receiving depository financial institution (RDFI) (or third party) 20. An ODFI may request or deliver funds. Transaction instructions and funds are linked using network defined Standard Entry Class (SEC) codes. These SEC codes identify the type of transaction being affected. Some examples of SEC codes include accounts receivable conversion (ARC), point-of-purchase (POP), Internet-initiated (WEB), telephone-initiated (TEL), and re-presented check (RCK). When the transaction is a credit transaction, the ODFI 10 sends funds and funds flow from the ODFI 10 to the RDFI 20. Examples of credit transactions include payroll direct deposits, Social Security payments, and dividend and interest payments. Corporate payments to contractors, vendors, or other third parties are also common ACH credit transactions. When the transaction is a debit transaction, the ODFI 10 requests funds and funds are deducted from a target account at the RDFI 20 and deposited to a target account at the ODFI 10. Examples of debit transactions include collection of insurance premiums, mortgage and loan payments, consumer bill payments, and corporate cash concentration transactions. FIG. 1 illustrates a credit transaction, while FIG. 2 illustrates a debit transaction.

FIG. 1 illustrates ACH credit clearing and settlement for a typical credit transaction 100. This transaction 100 is a direct deposit between an employer (payer) 30 and an employee (payee) 40. The employee (payee) 40 authorizes the employer (payer) 30 to deposit his or her paycheck through direct deposit (Step 1, 102). The ODFI 10 is the employer's (originator's) 30 financial institution and the RDFI 20 is the employee's (receiver's) 40 financial institution. The employer 30 submits its direct deposit payroll ACH files to the ODFI 10 (step 2, 104). The ODFI 10 verifies the ACH files and submits them through an ACH operator 50 (step 3, 106). The ACH operator 50 routes the transaction to the employee's (payee's) 40 financial institution (RDFI) 20, the employee's (payee's) 40 financial institution (RDFI) 20 makes the funds available to the employee (payee) 40 by crediting his or her account and debiting the employer's (payer's) 30 account at the ODFI 10 (steps 4 and 5, 108, 110). Then, the ACH operator 50 settles the transaction between the participating financial institutions 10, 20 (step 6, 112). Steps 1-5 represent a flow of information, while step 6 represents the flow of funds. If the ACH operator 50 is the privately held Electronics Payment Network (EPN), then final settlement is made using the Federal Reserve Bank's National Settlement Service (NSS). If the ACH operator 50 is the Federal Reserve, then final settlement is made directly to the financial institutions' 10, 20 reserve accounts at a Federal Reserve Bank.

FIG. 2 illustrates ACH debit clearing and settlement for a typical debit transaction 200. This transaction 200 is a recurring monthly insurance premium remittance between an insurance company (payee) 40 and a consumer (payer) 30. The consumer (payer) 30 sends the ACH payment information and authorization to the insurance company (payee) 40 (step 1, 202). The insurance company (payee) 40 submits this information to its financial institution (ODFI) 10 (step 2, 204), which routes the transaction to the ACH operator 50 (step 3, 206). The ACH operator 50 routes the transaction to the RDFI 20 (step 4, 208). Funds are made available to the account at the ODFI 10 for the insurance company (payee) 40 and the consumer's (payer's) 30 account at the RDFI 20 is debited (step 5, 210). Then, the ACH operator 50 settles the transactions between the ODFI 10 and the RDFI 20 (step 6, 212). Steps 1-5 represent a flow of information, while step 6 represents a flow of funds.

The ACH network allows funds to be electronically debited from or credited to a company's or individual's deposit account. These deposit accounts include checking and savings accounts. ACH credit transactions may be directed to loan accounts and ACH debit and credit transactions may be directed to financial institution general ledger accounts. ACH transactions carry basic entry details such as the individual name, financial institution, routing number, account number, amount, and effect date for the transaction.

In ACH credit and debit clearing and settlement as shown in FIGS. 1 and 2, a receiver 30, 40 authorizes an originator 30, 40 to initiate a transaction to/from their RDFI 20 account. The originator 30, 40 prepares information about the transactions that are to be automated (e.g., transactions for its consumers or employees) and passes this information to the ODFI (step 2, 104, 204). The ODFI 10 collects ACH transactions from participating companies, consolidates the ACH transactions in a batch file format, and presents the batch files to the ACH operator 50 (step 3, 106, 206). The ACH operator 50 is a central clearing facility operated by either a private organization (e.g., Electronic Payments Network (EPN)) or a Federal Reserve Bank on behalf of participating financial institutions 10, 20. The ACH operator 50.processes transaction files from submitting ODFIs 10 and distributes the transaction files to RDFIs 20. The RDFI 20 receives entries for its customer accounts and posts entries on the settlement date. Transactions are also reported on account statements.

Advances in technology have brought about significant changes in the volume and types of ACH activity. The growth in volume is attributable to fundamental changes in payment methods used by consumers and businesses. Recently, the Office of the Comptroller of Currency (OCC) has seen banks engage in new types of ACH activities without enhancing existing risk management systems and controls. Failure to implement appropriate controls for these activities is an unsafe and unsound practice that can result in increased credit risk, non-compliance, loss of reputation, strategic or competitive disadvantage, transaction risks, and, in some cases, may lead to a deterioration of the financial condition of the participant.

ACH origination volume has increased as consumers and businesses look for more cost-effective and convenient payment alternatives to more expensive methods such as wire transfers, paper checks, and credit card drafts. The cost of an ACH transaction is less than one penny per transaction, which is significantly less expensive than remitting funds by wire transfer, paper check, or credit card. The most pronounced growth in ACH transactions has been for nonrecurring payments. This is significant because in recurring transactions both the originators and receivers are traceable. The ACH network lacks systems to detect fraud and mechanisms to mitigate fraudulent transactions and recover stolen funds. Consumers may initiate a non-recurring transaction over the telephone, on the Internet, or simply by writing a check that is converted to an ACH transaction. Some common non-recurring payments types include accounts receivable conversion (ARC), point-of-purchase (POP), Internet-initiated (WEB), telephone-initiated (TEL), and re-presented check (RCK) entries.

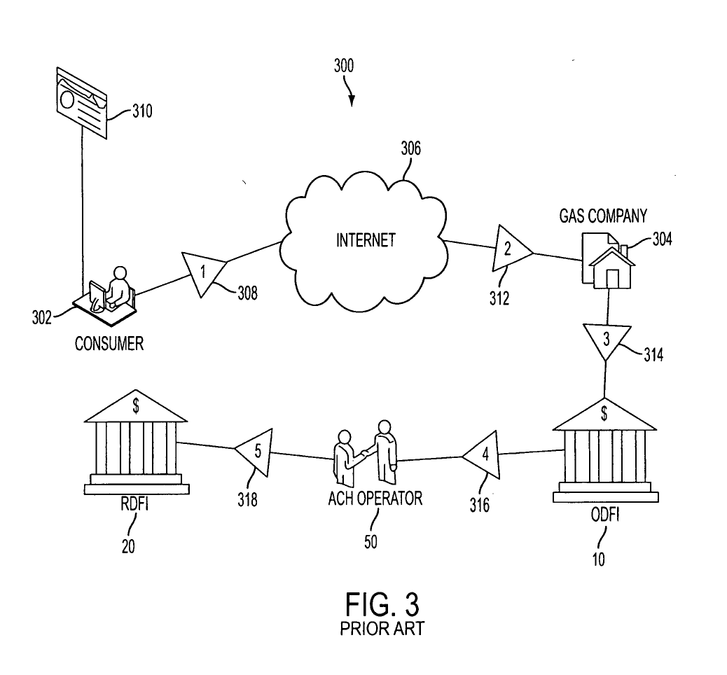

FIG. 3 illustrates a typical Internet-initiated (WEB) ACH transaction 300 for a consumer 302 paying a bill to a gas company 304. The consumer 302 authorizes payment at the gas company's 304 website on the Internet 306 (step 1, 308) by, for example, entering the RDFI routing number, account number, and amount of the bill 310. The authorization is sent to the gas company 306 (step 2, 312). The gas company 304 provides the consumer's 302 account details to their bank (ODFI) 10 and the ODFI 10 credits the gas company's 304 deposit account (step 3, 314). The ODFI contacts the ACH operator 50 to send the debit notification to the RDFI 20 and the ODFI 's 10 Federal Reserve bank account is credited for the amount authorized (step 4, 316). The RDFI 20 initiates the debit to the consumer's 302 deposit account at the RDFI 20 for the authorized amount (step 5, 318).

In addition to the example of FIG. 3, the consumer 302 could have mailed a check to the gas company 304. At that point, the gas company 304 could use the information on the check (e.g., account number, bank routing number, and amount) to create an ACH transaction. This is an example of an Accounts Receivable Conversion (ARC) ACH transaction. Alternatively, the consumer 302 could have telephoned the gas company 304 and provided information for an ACH transaction. This is an example of a telephone (TEL) ACH transaction. The consumer 302 could write a check for payment of merchandise at the gas company 304. This is an example of a point-of-purchase (POP) ACH transaction. In this example, the gas company 304 runs the check through its magnetic ink character recognition (MICR) equipment to capture the information (e.g., consumer account information, RDFI routing number, amount, check number) and obtains the consumer's 302 authorization. The “cancelled” check is then returned to the consumer 302 and the transaction is then effected. In a back office conversion (BOC), the gas company 304 could convert the consumer's 302 check to an ACH debit using electronic conversion equipment at the point-of-purchase or at a manned location.

In addition to new and evolving types of ACH transactions, there are new participants in the ACH network, including certain merchants and third parties known as third-party senders. The onset of mobile payments via cell phone is the USA, which is already prevalent in Europe and Japan, will further enhance the risk exposure in the ACH network as these and other types of transactions gain prominence.

The OCC has urged depository financial institutions (DFIs) to exercise extra vigilance over their ACH activity and adopt risk management activities to stem the rising incidence of ACH fraud. The OCC recommendations exceed the current regulatory requirements established by the National Automated Clearing House Association (NACHA). NACHA is a nonprofit association that was created by Congress to oversee the ACH network.

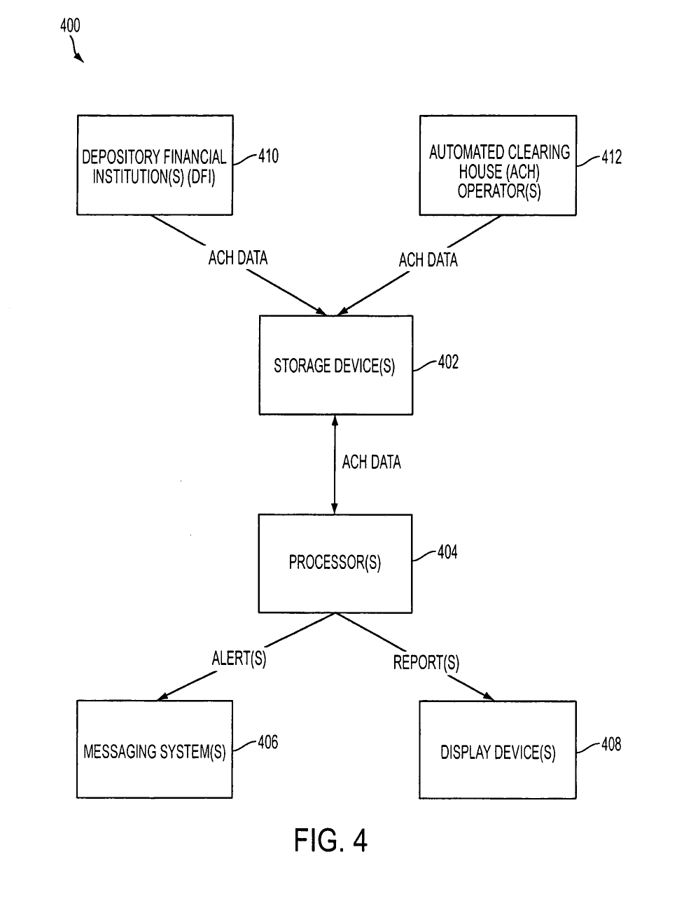

FIG. 4 shows an exemplary embodiment of a system 400 for processing ACH historical data. ACH historical data is data captured from ACH transactions, such as, for example, those illustrated in FIGS. 1-3. The ACH historical data may be captured and stored in various ways. For example, ACH historical data may be transformed into different formats or data structures and some data may be added or omitted to facilitate processing. The system 400 includes one or more storage devices 402, one or more processors 404, one or more messaging systems 406, and one or more display devices 408. The storage device 402 collects ACH historical data from one or more depository financial institutions (DFIs) and one or more ACH operators 412. The processor 404 processes the ACH historical data and may provide one or more alerts to the messaging system 406 and/or one or more reports to the display device 408.

The storage device 402 is any kind of storage device accessible by a processor now or in the future and may include one or more of various kinds of database management systems, such as relational, hierarchical, network, object or any other kind. The system 400 may have various different kinds of storage devices 402 and one or more of the storage devices 402 may be external to the system 400 and in communication with the system 400 by, for example, a network. One or more storage device 402 associated with the processor 404 stores instructions for performing various methods described herein on the processor 404, such as a reconciler component, a risk management component, a pattern matching component, a distribution component, and various other components.

The processor 404 is a processing element (e.g., central processing unit (CPU)) that may be part of any kind of computing machine capable of processing ACH historical data now or in the future, such as a desktop computer, server, personal computer, embedded system, cell phone, distributed computing system, supercomputer, or another kind of computing machine. The processor may also include database elements for interacting with the storage device 402, such as database management, data mining, pattern matching, web services, query processing, security, and other technologies. Alternatively, such technologies may be included in whole or in part on the storage device or on other systems outside of and in communication with the system 400.

The messaging system 406 is any kind of communications system now or in the future, such as, for example, electronic mail (email). For example, the processor 404 may generate an alert message and pass the alert to the messaging system 406 to notify a DFI of an ACH rule violation. The messaging system 406 may be a part of the system 400 or may be included in whole or in part outside and in communication with the system 400.

The display device 408 is any kind of device for providing reports from the system 400 now or in the future, such as, for example, a monitor or a printer. For example, the processor 404 may generate a report to be displayed on the display device 408 showing a time distribution of ACH returns. The display device 408 may be a part of the system 400 or may be included in whole or in part outside and in communication with the system 400.

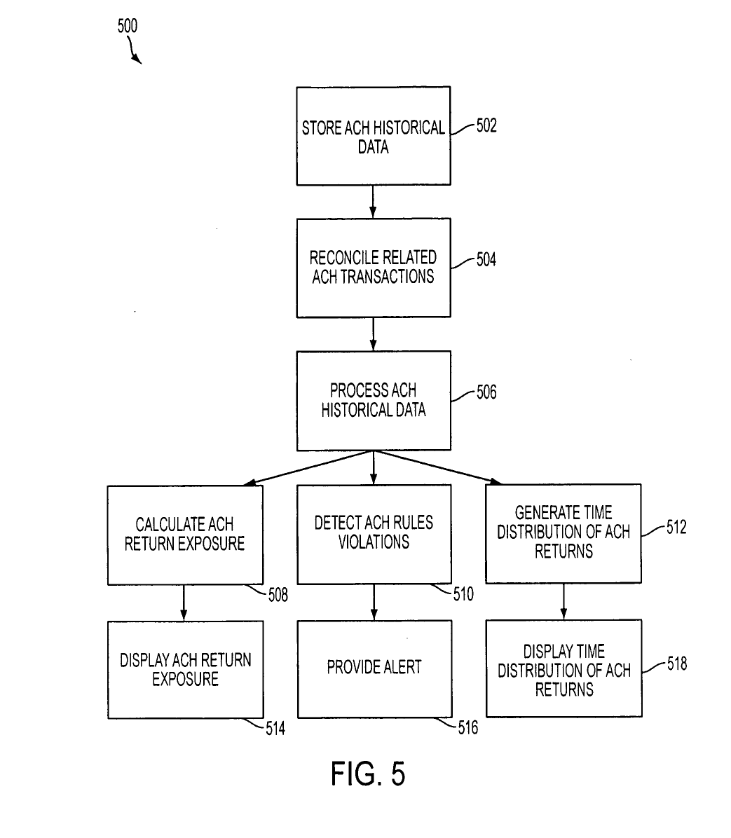

FIG. 5 shows an exemplary method 500 for processing ACH historical data. ACH historical data is captured and stored 502 from a set of ACH transactions to be processed. Related ACH transactions are identified 504 to facilitate processing and this identification of related ACH transactions may be stored separately or together with the ACH historical data. The ACH transactions may be processed 506 in one or more of the following ways: calculating ACH return exposure 508, detecting one or more ACH rule violations 510, and/or generating a time distribution of ACH returns 512. After processing, any results may be provided by displaying an indication of ACH return exposure 514, providing one or more alert 516, and/or displaying one or more time distributions of ACH returns 518.

The method 500 of FIG. 5 may be performed by the system 400 of FIG. 4 as follows. ACH historical data from at least one DFI 410 and at least one ACH operator 412 is stored in one or more storage device 402. A reconciler component capable of executing on the processor 404 identifies related ACH transactions in the ACH historical data. A risk management component capable of executing on the processor 404 calculates an ACH return exposure for display on the display device 408. A pattern matching component capable of executing on the processor 404 detects at least one ACH rule violation and provides at least one alert through the messaging system 406. A distribution component capable of executing on the processor 404 generates at least one time distribution of ACH returns for display on the display device 408.

An exemplary embodiment of the system 400, the method 500, and computer program product for processing ACH historical data may include software tools for use by DFIs to perform functions such as, for example, searching, analyzing and viewing ACH historical data from various perspectives to gain visibility into emerging activity trends (e.g., SEC code, originator, etc.), proactively anticipating fraud, and complying with NACHA regulatory reporting requirements. The software tools may be deployed within a DFI's own data network, through a managed service offering, referred to as software as a service, or any other way. DFIs may interact with the software via a standalone software application or a browser. In one embodiment, the software tools use a multidimensional database, (e.g., an online analytical processing (OLAP) cube) which is capable of summarizing millions or even billions of ACH transactions. In addition, the software tools may include various logic- and rule-based techniques to detect anomalies in patterns of ACH transaction originations at various levels of aggregation. For example, the software may detect a sudden spike in volume from a particular Internet store and alert the concerned ODFI that the limit on the amount of transaction permitted has been exceeded for a specific SEC code. Alternatively, the software may alert the ODFI of a sudden spike in volume across all Internet-based transactions across all originators. This information may be depicted, for example, in a chart or graph. Furthermore, the software tools may detect exceptions, such as, for example, rules violations in ACH historical data captured in route to and from the ACH operators, such as those mandated by the Federal Reserve Board and NACHA. The software tools may produce an alert to an ODFI or RDFI, as appropriate, enabling them to avoid costly penalties. The software tools may facilitate and simplify the process of reporting violations. This exemplary embodiment of software tools may be embodied in a software and/or hardware configuration that may be installed within a customer's data center on a standalone basis, provided through a managed service offering, or provided otherwise. This exemplary embodiment of software tools may perform various methods, such as the method 500 of FIG. 5. ACH data may be captured from a DFI's native file system at various time intervals. DFI data may be captured from an ACH operator and a store and forward component may provide data to a concerned DFI at various time intervals. ACH data may be processed using logic- and rule-based techniques. Security may be provided for the ACH data. ACH data may be manipulated by using data warehouses and OLAP cubes, for example. Rule violations may be reported and irregular item return activity may be provided. The results of processing the ACH data may be provided in a display.

An exemplary embodiment of the system 400, the method 500, and computer program product for processing ACH historical data may include software tools that use a multidimensional database or OLAP cube. An OLAP cube is a data structure that segments data to permit fast analysis of data contained within the cube. The arrangement of data into cubes overcomes a limitation of relational databases which are commonly used for managing data. Relational databases are not well suited for analysis and display of large amounts of data. As such, the arrangement of data into cubes using the OLAP format allows for more efficient and near instantaneous analysis and display of large amounts of data. Instead, relational databases are better suited for creating records from a series of transactions known as on-line transaction processing (OLTP). Although many report writing tools exist for relational database, the processing times are slow when summary of an entire database is required. There is a need for a system to handle several billions of transactions per year. One bank generated nearly fifteen million (15 M) ACH transactions each day, whereas more than fifteen billion (15 B) transactions are processed by the ACH network each year. For efficient processing and analysis of data of this magnitude, it is desirable to use an OLAP cube.

An OLAP cube may be used as follows. A financial analyst might want to view or pivot the data in various ways, such as displaying all the cities down the page and all the products across a page. A slice is a set of row and column definitions that can be pivoted. This could be for a specified period, version, and type of expenditure. Having seen the data in this particular way, the analyst might then immediately wish to view it another way. The cube could effectively be re-oriented so that the data displayed now had periods across the page and type summarizing very large amounts of data. It is desirable for this new view of the data to be generated efficiently to avoid wasting the analyst's time, e.g., within seconds, rather than the hours a relational database and conventional report-writer might need.

An exemplary embodiment of the system 400, the method 500, and computer program product for processing ACH historical data may include software tools having various logic- and rule-based techniques that are applied within the software to detect anomalies in patterns of ACH transaction originations at various levels of aggregation. For example, the software may detect a sudden spike in volume from a particular Internet store and alert the concerned ODFI of this blip in activity (e.g., limit on amount of transaction dollar permitted has been exceeded for a specific SEC code) per day. Alternatively, the software may alert the ODFI of a sudden spike in volume across all Internet-based transactions across all originators. This information may be depicted in the form of data in columnar fashion or in graphical form to provide better visual cues to the analyst. Further, since the ACH data may be captured en route to and from the ACH operator (See FIGS. 1-3), the software may also detect violations of network rules mandated by the Federal Reserve Board and NACHA and produce an alert to the ODFI or RDFI, as appropriate, of the violation(s), thus enabling the DFI to avoid costly penalties. Finally, the process of reporting violations, made cumbersome by the detailed federal reporting requirements, may be greatly simplified by the software due to the various ways in which data may be handled and stored.

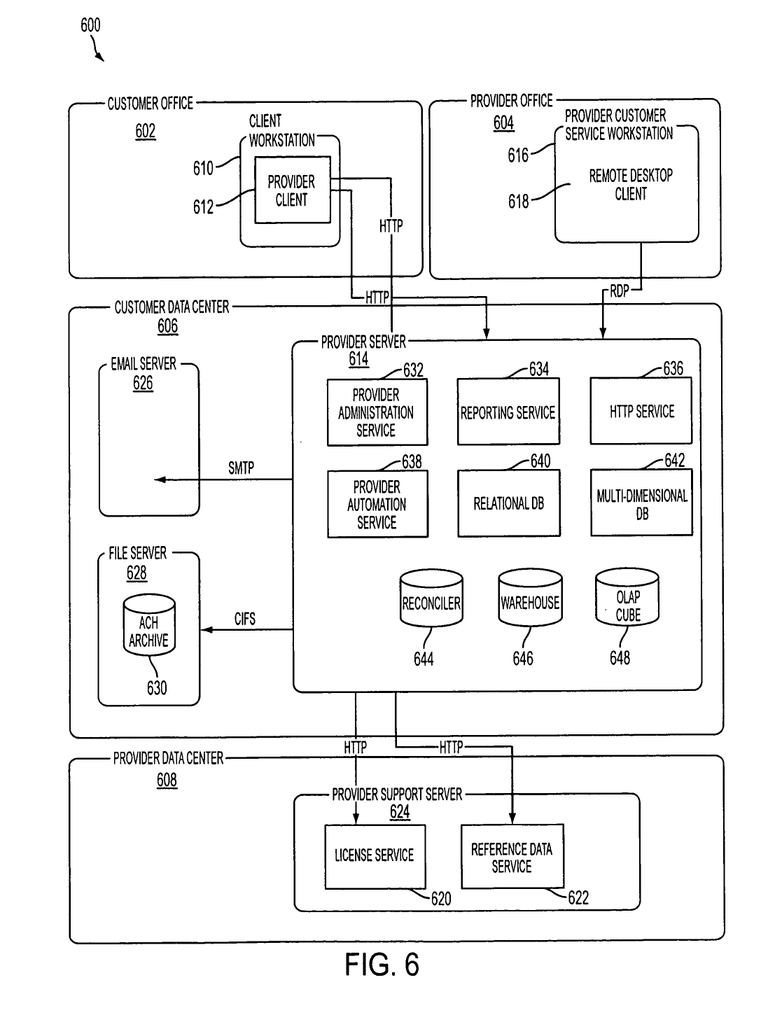

FIG. 6 shows an exemplary embodiment of a system 600 for processing ACH historical data by a provider for a customer. The system 600 may be deployed at a customer location and integrated with the customer's information technology (IT) infrastructure or the system 600 may be hosted at a provider location and provided in a managed service context as software as a service. The system 600 includes a customer office 602, a provider office 604, a customer data center 606, and a provider data center 608. The system 600 is one exemplary embodiment; however systems for processing ACH historical data described herein are not limited to this exemplary embodiment and may be designed and implemented in many different ways.

The customer office 602 may include a client workstation 610, which includes a provider client 612 for communicating with a provider server 614 using a communications protocol, such as, for example, hypertext transfer protocol (HTTP). The customer workstation 610 may reside at any or all of the customer's locations geographically. The customer may use the customer workstation 610 to, for example, view reports, or adjust the behavior of the provider server 614. The provider office 604 may include a provider customer service workstation 616, which includes a remote desktop client 618 for communicating with the provider server 614 using a communications protocol, such as, for example, Remote Desktop Protocol (RDP). Provider support staff may access the provider server 614 to, for example, review transaction data at the behest of the customer or investigate issues raised by the customer.

The customer data center 606 may include the provider server 614, an email server 626, and a file server 628, which includes an ACH archive storage device 630. The provider server 614 may interacts with the email server 626 via a protocol for electronic mail, such as, for example simple mail transfer protocol (SMTP). The provider server 614 may interact with the file server 628 via a file service, such as, for example, common Internet file system (CIFS). The email server 626 may belong to the customer and may be used to provide the customer with pre-scheduled and/or alert-based delivery of reports. The file server 626 may access the customer file system to capture outbound and inbound ACH transactions to/from the DFIs or ACH operators.

The provider server 614 may interact (via a communications protocol, such as, for example, HTTP) with the provider data center 608 to monitor licenses issued to customers via the license service 620 and to retrieve customer data from the Federal Reserve Board via the reference data service 622. A provider support server 624 holds the license service 620 and reference data service 622 within the provider data center 608. The provider server 614 may include a provider administration service 632, a reporting service 634, an HTTP service 636, a provider automation service 638, a relational database 640, a multidimensional database 642, a reconciler database 644, a warehouse 646, and an OLAP cube 648. The provider server 614 is one exemplary embodiment; however systems for processing ACH historical data described herein are not limited to this exemplary embodiment and may be designed and implemented in many different ways.

The provider administration service 632 may perform various administrative services for the provider server 614.

The reporting service 634 may provide various reporting services for the provider server 614.

The HTTP service 636 may provide various web services for the provider server 614.

The provider automation service 638 may provide an archive monitoring service to the provider server 614 by accessing ACH files from the ACH archive 630 on the customer file server 628. The provider automation service 638 may obtain a table of data including financial institution names and routing and transit numbers (RTN)) from a federal website to be stored and forwarded to a concerned customer only. The provider automation service 632 may update the warehouse 646 database through a warehouse controller service. The provider automation service 632 may generate alerts when anomalies in the ACH historical data are detected by the provider server 614. The provider automation service 632 may provide reporting services from a combination of reporting services 634 based on queries of the relational database 640 and/or from multidimensional database 642 that extract data from the OLAP cube 648. The provider automation service 638 may communicate with the client workstation 610 from a web server, such as, for example, the HTTP service 636.

The relational database 640 may provide database services for the provider server 614.

The multidimensional database 642 may provide analytical services for the provider server 614.

The reconciler database 644 holds tagged entries paired with tagged returns.

The OLAP cube 648 is populated from the warehouse database 646, allowing rapid data analysis.

The warehouse database 646 may hold reconciled items.

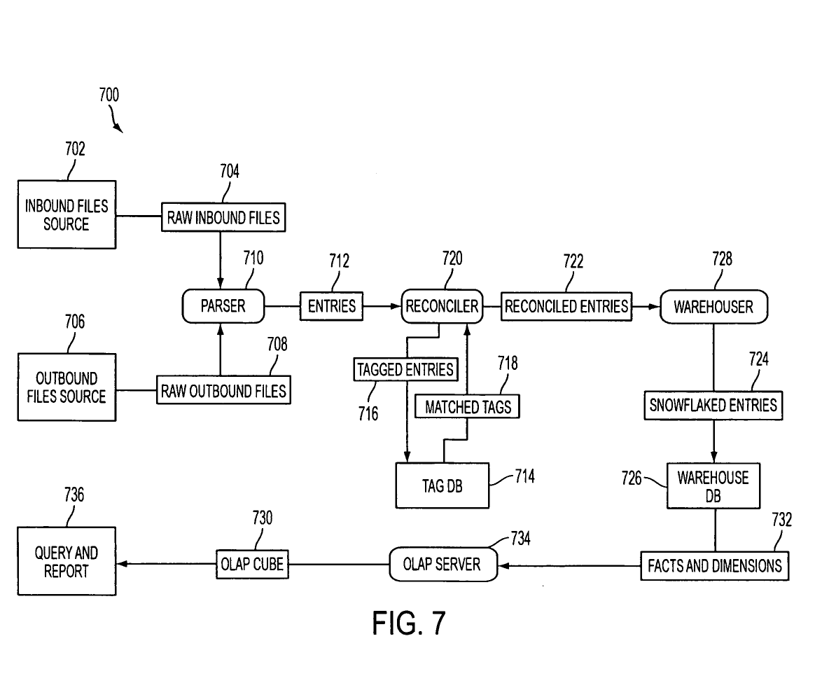

FIG. 7 shows an exemplary embodiment of a method 700 of processing ACH historical data with the system 600 of FIG. 6. An inbound files source 702 may provide raw inbound files 704 and an outbound files source 706 may provide raw outbound files 708 to a parser 710. For example, the raw inbound files 704 may be received from the ACH operator 50 of FIGS. 1-3 and the raw outbound files 708 may be sent to the ACH operator 50 of FIGS. 1-3. The raw inbound files 704 and the raw outbound files 708 are raw NACHA-formatted ACH files. The parser 710 parses the files 704, 708 from an hierarchical file/batch/entry/addenda structure of the NACHA file into a flattened form that discards portions of the ACH having no relevance to the method 700 of processing ACH historical data and may normalize all entry types into a single representation. The flattened entries 712 may be tagged using a tag database 714. The tagged entries 716 may be matched with tags 718 and inserted into the reconciler database 720, where a variety of queries and methods may be used to identify related entries and identify various patterns among those entries to create reconciled entries 722. Reconciled entries 722 may be annotated with relationship information in a snowflake schema to create snowflaked entries 724 that are stored in the warehouse database 726 by a warehouser method 728.

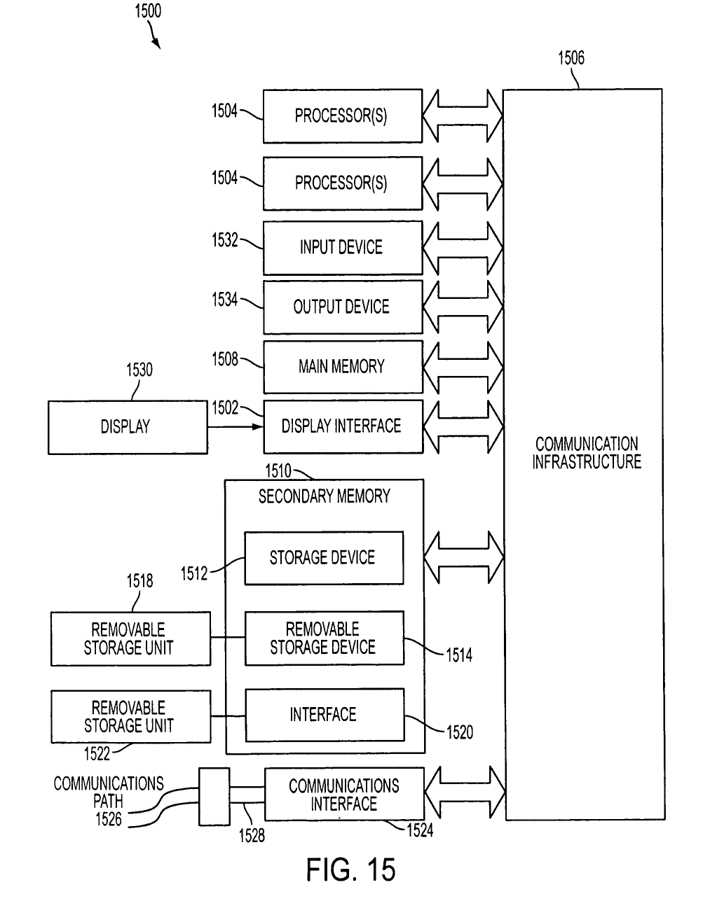

At least one OLAP cube 730 may be constructed from facts and dimensions 732 derived from the ACH data in the warehouse database 726 by an OLAP server 734. At this point, one or more queries 736 may be performed on the OLAP cube. 730 to create one or more reports 736. The query 736 may be in a query language for OLAP databases, such as, for example, Multidimensional Expressions (MDX). Some examples of fact data 732 include entry count, entry amount, return count, return amount, credit entry count, credit entry amount, and many others. Some examples of dimension data 732 include dates, ACH file identifiers, ACH file dates, ACH file sizes, ACH file counts, ACH file amounts, bank routing numbers, bank names, originator identifiers, originator names, and many others. Dimension data may be static or dynamic. Some examples of reports 736 are illustrated in FIGS. 15A-15E.

In summary, the method 700 of FIG. 7 of processing ACH historical data with the system 600 of FIG. 6 includes obtaining ACH data 704, 708, parsing the ACH data 710, tagging the ACH data 714, 716, 718, and storing it in a warehouse database 726. Relevant data may be moved from the warehouse database 726 to the OLAP cube 730 to facilitate rapid responses to queries 736. Any anomalies detected in the ACH data by the method 700 and system 600 may be presented to the customer via alerts to the email server. In addition, any financial institution data changed by the Federal Reserve System may be retrieved and updated by the provider server 614. The customer may view the ACH data through reports generated by the provider server 614 and displayed by the provider client 612 on the client workstation 610. The customer may adjust the settings 714 of the provider server 614 to adjust its behavior, such as, for example, the reports generated.

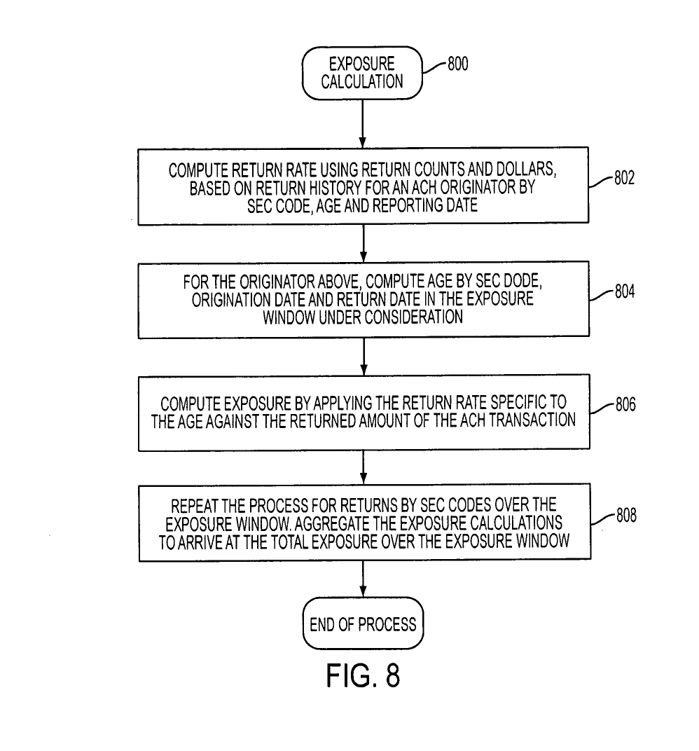

FIG. 8 shows an exemplary method 800 of calculating an ACH return exposure. The method 800 may identify areas of ACH risk using the OLAP cube 730 of FIG. 7. A return rate may be computed using, for example, return counts and dollars, based on return history for an ACH originator by SEC code, age, and reporting date (step 802). For this originator, an age by SEC code, origination date, and return date may be computed for an exposure window under consideration (step 804). Exposure may be computed by applying the return rate specific to the age against the returned amount of the ACH transaction (step 806). Steps 802-806 may be repeated for returns by SEC codes over the exposure window. The exposure calculations may be aggregated to arrive at a total exposure over the exposure window.

This method 800 may calculate discounted ACH debit exposure using either return count or return value weighting, which is better than traditional methods. Traditional methods of estimating risk exposure relay on simple average calculations that are likely to miss lumpy activity at either end of the time horizon under consideration due to the tendency of such calculations to flatten out perturbations with an averaging process. Similarly, setting a reserve for losses based on the resulting average(s) falls short of the coverage needed to account for spikes that may occur at the-tail end of a typical time band.

Origination of ACH debit transactions may result in an unsecured debit obligation for the ODFI 10 (FIGS. 1-3). Returned ACH debit transactions constitute a form of loss for the ODFI 10 that may be passed on to the ODFI's customer (the originator). While the total exposure for a given set of originations is easily calculated, it is many times larger than the expected loss that may actually result from those originations. A highly predictive exposure may be calculated using the method 800 by, for example, weighting originations with actual return rate data gleaned from monitoring previous originations and returns by the same originators under the same business rules. Different exposure calculations may be defined based on a count- or value-weighted return history.

Conventional ACH exposure calculations may calculate the total of all debit originations in the past 60 calendar days for each combination of originator and SEC code. This results in a worst-case exposure if every debit was returned and is largely useless because it is about fifty to a hundred times larger than the expected loss in any realistic scenario. Another conventional approach is to calculate the gross exposure and then simply multiply by the gross return rate of the originator. This yields a number that is closer to the actual expected loss, but does not take into account the return aging history of the originator. For example, suppose an originator has a statistically significant amount of history that shows that 99% of their returns come in within the first four days of the 60 day return window. Calculating exposure this way yields an exposure estimate that will be about fifteen times higher than the actual expected loss, because all originations in the 60 day exposure window have been equally weighted. Similarly, suppose an originator normally originates small files, but on one day originates an unusually large file. Depending on the return history of the originator and the number of days since the large file was originated, the second approach will yield an estimate that is either significantly too high or significantly too low. This anomaly is a result of all days being weighted equally.

Another problem with the conventional methods is an inaccurate calculation of return rate (e.g., for every 100 entries originated, how many are returned). Most of the conventional methods do not calculate return rate at all and those that do calculate return rate as a simple ratio of entries sent versus returns received. In a large system operating under steady state conditions, this gross calculation may be a reasonable estimate of the expected return rate; however, in a system that is in constant flux, it can lead to an estimated return rate that loses important information. For example, suppose an originator sends out one file of 1,000 entries per day and within a particular month each file that is sent out 0.2% of the entries are returned, except for one file that had 45% of its entries returned. The gross return rate calculation given above would yield a return rate in this case of 2% because of the equal weighting of all the originated files. In a real world scenario, a file with an unusually high return rate is typically indicative of a fraud event and the resulting returns are “late returns,” coming back with ages that range from 4-60 days. There is a need for a calculation of return rate that takes into account these file-by-file differences as and when they occur.

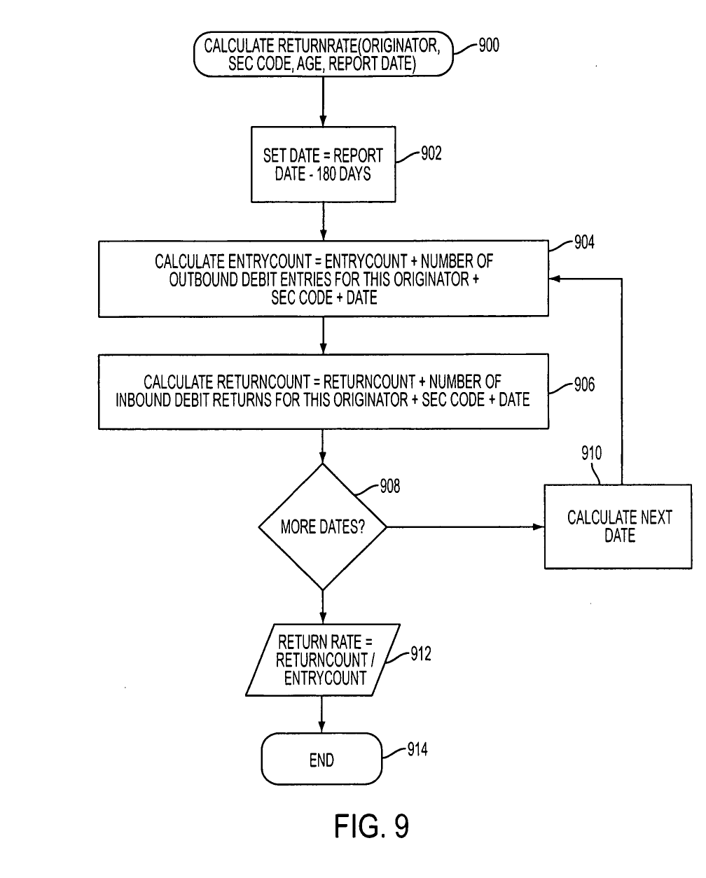

FIG. 9 shows an exemplary method 900 of calculating return rate. Return rate may be measured by count and/or dollars. If ten items were originated for a total of $1,000 and two were returned for $500, then the return rate would be 20% and the return share would be 50% across all items. The return rate may be computed in various different ways, such as, for example, by originator, SEC code, ODFI, over a cycle, such as 180 days, and the like. For example, if Joe's flower shop experiences a 0.95% return share on day ten and ABC is interested in knowing what the return exposure is for ACH originations submitted on Aug. 1, 2008 for $10,000, the rate is applied to the origination amount. In this example, the loss exposure on Aug. 11, 2008 is $95.

In FIG. 9, the method 900 calculates a return rate given an originator, an SEC code, an age, and a report date by setting the date equal to the report date minus 180 days (step 902). At the top of a loop, the entry count is equal to the entry count plus the number of outbound debit entries for this originator plus the SEC code plus the date (step 904). Inside the loop, the return count is set equal to the return count plus the number of inbound debit returns for this originator plus the SEC code plus the date (step 906). If there are more dates (step 908), the next date is calculated (step 910) and control returns to the top of the loop (step 904). Otherwise, the return rate is equal to the return count divided by the entry count (step 912) and the method 900 ends (step 914).

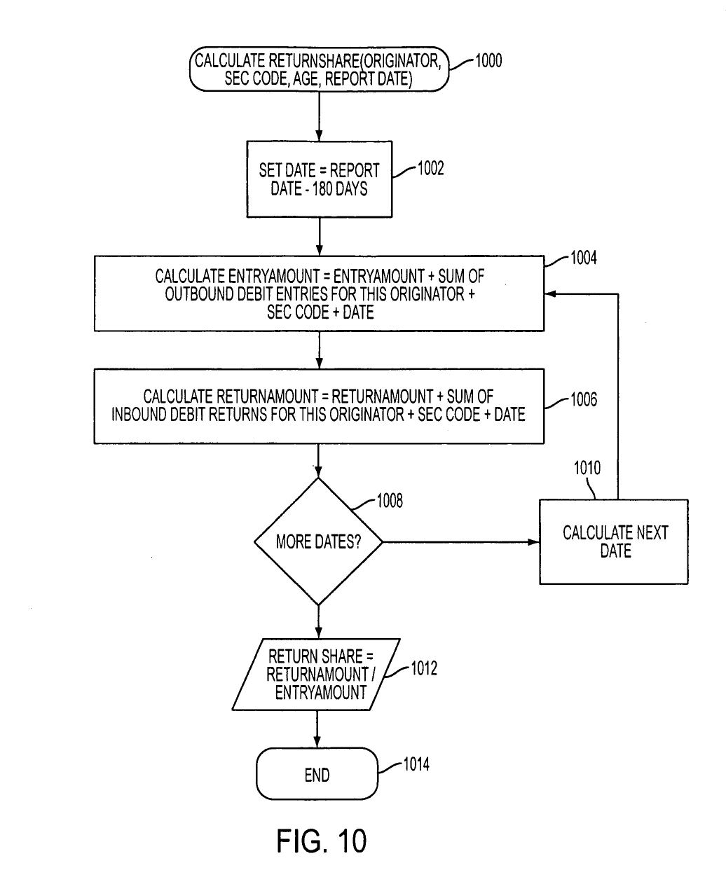

FIG. 10 shows an exemplary method 1000 of calculating return share. The method 1000 calculates a return share given an originator, an SEC code, an age, and a report date by setting the date equal to the report date minus 180 days (step 1002). At the top of a loop, the entry amount is equal to the entry amount plus the sum of outbound debit entries for this operator plus the SEC code plus the date (step 1004. Inside the loop, the return amount is set equal to the return amount plus the sum of inbound debit returns for this originator plus the SEC code plus the date 9 step 1006). If there are more dates (step 1008), the next date is calculated (step 1010) and control returns to the top of the loop (step 1004). Otherwise, the return share is equal to the return amount divided by the entry amount (step 1012) and the method 1000 ends (step 1014).

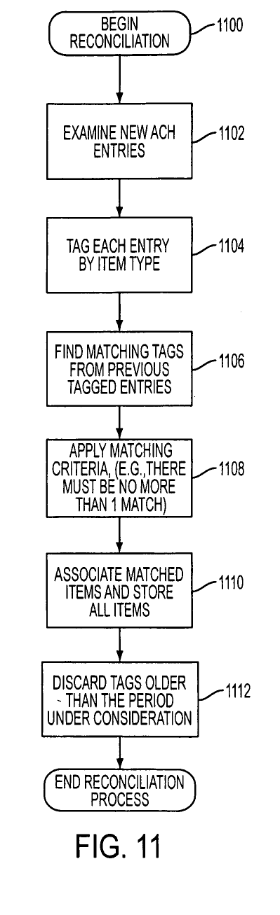

FIG. 11 shows an exemplary method 1100 of identifying related ACH transactions (reconciliation). The method 1100 may include examining new ACH entries (step 1102), tagging each entry by item type (e.g., entry, return, etc.) (step 1104), finding matching tags from previously tagged entries (step 1106), applying matching criteria (e.g., there must be no more than one match) (step 1108), associating matched items and storing all items (step 1110), and discarding tags older than the period under consideration (step 1112). Some examples of item types include entry, return, dishonored return, contested dishonored return, notification of change, and refused notification of change.

Individual ACH entries exist within the context of a larger flow of entries between an originator and a receiver. Under the umbrella of a single originator/receiver pair, there exist a number of transactions, each of which includes of one or more ACH items. The various items that make up a single transaction may be separated in time by 60 or more days. Keys embedded in the ACH data that were designed to allow related entries to be grouped together are frequently corrupted by systems or personnel involved in the transaction, making the association of these entries difficult, if not impossible. Identifying related ACH entries is desirable for several reasons. First, it provides one way of calculating the return age needed by the previous method. Once a return has been matched with a related original entry, the return age may be calculated by simply subtracting the transmission dates of the return and the entry. ACH entries flow through the ACH network according to a series of rules (or protocols). Typically, violations of the rules set forth by NACHA are not detected unless an account holder complains to their DFI and, upon subsequent investigation, the violation is uncovered. Therefore, identifying related ACH entries allows rule violations to be more easily detected. Knowing the various relationships between entries allows information about the ACH entries to be presented to customers in a more understandable manner, because related entries may be presented grouped together even if they span months, years, or other time periods.

The agencies that operate the ACH network, the Federal Reserve Bank and the Electronic Payments Network, have stated that identifying related ACH entries is impossible and/or impractical. Few conventional systems make any attempt to identify associations between related entries. One system identifies related ACH entries by examining many combinations of fields for exact matches and, if a sufficiently good match is found, the ACH entries are considered to be related. However, this system does not scale up due to the computational complexity of this method. Another problem with this system is the storage of full fidelity copies of all of the ACH entries involved. Such full fidelity copies represent a large and unacceptable security risk, because the ACH entries contain correlated sets of routing number, account number, and name.

The method 1100 may use hashed surrogate keys derived from the original ACH entries, allowing related ACH entries to be identified and associated without storing any sensitive data that may be a security risk. A system performing the method 1000 may be scaled up to handle, for example, the entire volume of the ACH network. For increased capacity, input files may be split into several buckets (e.g., a data storage area or data structure on a storage device), which may then be processed sequentially (i.e., on a single machine) or in parallel (i.e., on multiple machines) so that the reconciler size and system memory capacity is somewhat independent. By using the method 1000 with several different tag building methods, it is possible to identify several different kinds of relationships between entries at the same time.

The method 1100 may be scaled up by, for example, partitioning the data either by time or by value. First, partitioning by time allows data to be efficiently removed from the database by dropping large collections of data at one time, instead of deleting individual tags as they age. Second, partitioning by value allows the processing to be split into several independent processing units. Partitioning by value may be done by using a hash function to combine the ODFI, RDFI, originator and receiver into a single has key, which may then be used to select one of several buckets into which the entry is placed. The hash key may be selected so that all related entries fall into the same bucket. In this way, matches occur in the same bucket, making the database search problem more tractable. The various buckets may be processed in parallel on several computers or one at a time on a single computer.

An exemplary embodiment of a method of detecting ACH rules violations may use pattern matching. NACHA defines rules (or protocols) that mandate valid sequences of ACH entries and transactions between an originator and a receiver. When an originator fails to adhere to the rules, a fine may be assessed by NACHA under the national System of Fines. The method may use pattern matching to detect rules violations when presented with a collection of ACH entries and transactions between an originator and a receiver. Pattern matching may include various techniques such as, for example, regular expressions and exact sub-string matching. This method is fast and easily scalable to a large number of rules. This method of detecting rule violations may use various methods of identifying related ACH entries.

The method of detecting ACH rules violations may match token sequences derived from ACH items against a database of known violation patterns using a formal grammar. Tokens may be expressed as a sequence of characters (words) and known violation patterns may be expressed as regular expressions. Examples of tokens include En=normal entry and Er=entry reversal. ACH entries may be examined and converted into expressions made up of a number of components. For example, the following four components may be used:
1. Tokens;
2. An index for the entry to ensure the entry is for the same transaction;
3. An index to ensure the entry is for the same dollar amount; and
4. An index for similar sign (i.e., credit or debit).

The expressions may be matched against known expressions of rules violations. Two examples of such known expressions are ̂En000Ra100En100, which indicates a re-initiation after an unauthorized return and ̂En000Ri100En100Ri300En300Ri500En500, which indicates excess re-initiation of insufficient funds. In the first example, the pattern ̂En000Ra100En100 matches anything that begins with the character sequence ̂En000Ra100En100.

The method may construct tokens according to a set of rules, such as, for example: {Ty} {T} {A} {C}, where:
Ty is chosen from the following table;
T is a single digit representing the 0-based index into the ordered collection of tokens of the first item that belongs to the same transaction as the item being encoded;
A is a single digit representing the 0-based index into the ordered collection of tokens of the first time that has the same dollar amount as the item being encoded; and
C is a single digit representing the 0-based index into the ordered collection of tokens of the first item that has the same sign (i.e., credit or debit) as the item being encoded.

TABLE 1
Examples of choices of tokens for various item types for Ty.

| Token | Item Type |
|---|---|
| En | An entry that is not a prenote or reversal |
| Ep | An entry that is a prenote |
| Er | An entry that is a reversal |
| Ra | An unauthorized return |
| Ri | An insufficient funds return |
| Rv | An invalid account number return |
| Ro | Any other kind of return |
| Rd | A dishonored return |
| Rc | A contested dishonored return |
| No | A notification of change |
| Nr | A refused notification of change |

The grammar and language construction may be used to detect any kind of pattern, including rules violations. Two examples of rule violation patterns are ̂En000Ra100En100, which indicates a re-initiation after an unauthorized return and ̂En000Ri100En100Ri300En300Ri500En500, which indicates an excess re-initiation of insufficient funds. Some patterns may be augmented with additional checks, such as a check of the timespan between entries that otherwise fit the desired pattern.

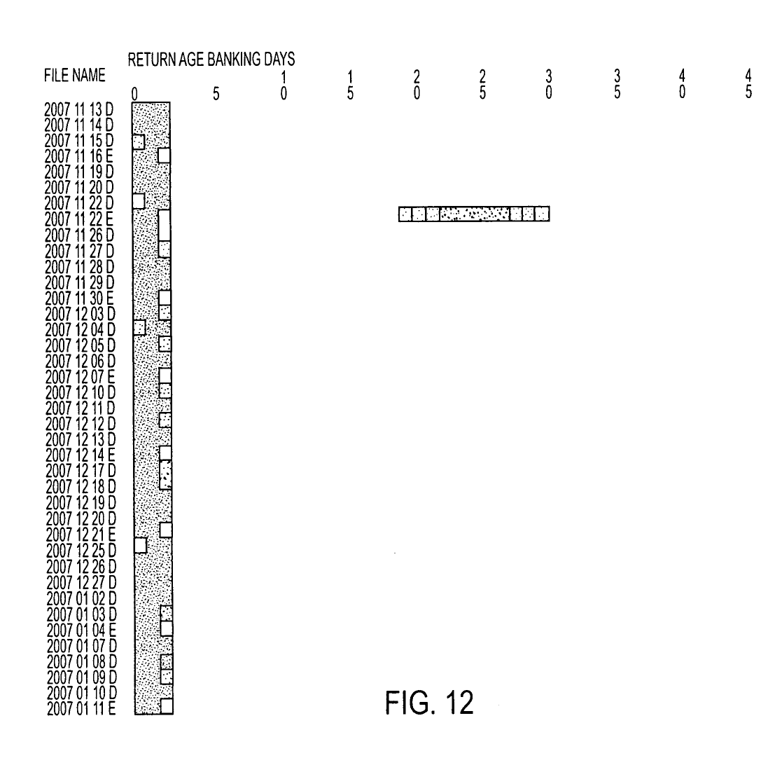

FIG. 12 shows an exemplary embodiment of a chart showing an exemplary time distribution of ACH returns by origination file or date. ACH debit exposure may result from outbound debits and have a lifetime of three (3) to 60 days, depending on the business rules under which the entries were originated. Nefarious individuals may at times succeed in introducing fraudulent transactions into origination files. The returns from such files may appear mixed together with other returns consequently may be difficult to identify due to their relatively small contribution to the overall transaction flow. The time distribution of ACH returns allows someone to, for example, quickly view return patterns for hundreds of origination files or dates over a period of several weeks to quickly identify undesirable return patterns that my indicate a fraud event. The method for providing the time distribution of ACH returns may aggregate entries by files. While FIG. 12 shows an exemplary embodiment of the chart, there are many different ways that this information may be displayed in a manner that takes advantage of the human eye's ability to recognize patterns in the data shown on the chart.

FIG. 12 illustrates an exemplary display of a return age by file chart. Along the left edge is a column of file dates and their corresponding file identifier (ID) modifiers. Across the top of the chart is a scale of return ages from 0 to 45, because 45 banking days corresponds to the maximum return window allowable under the NACHA rules of 60 calendar days. Each cell in the chart may represent the number of returns for the file on that row that had the return age of that column so that the darker the cell, the more returns were received for that file with that age. The shading of the cells from row to row may be normalized so that a fully black cell represents 100% of returns for that file, regardless of how many entries were in the original file. The display makes it easy to spot files with unusual return patterns. For example, if a file had been originated that contained a significant number of fraudulent entries, one would see a pattern such as the one shown in FIG. 12 for file 2007 11 22 D, which has non-white squares to the right of 3 banking days. By contrast, a normal origination file that does not suffer from a high return rate will typically have nearly zero non-white squares to the right of 3 banking days.

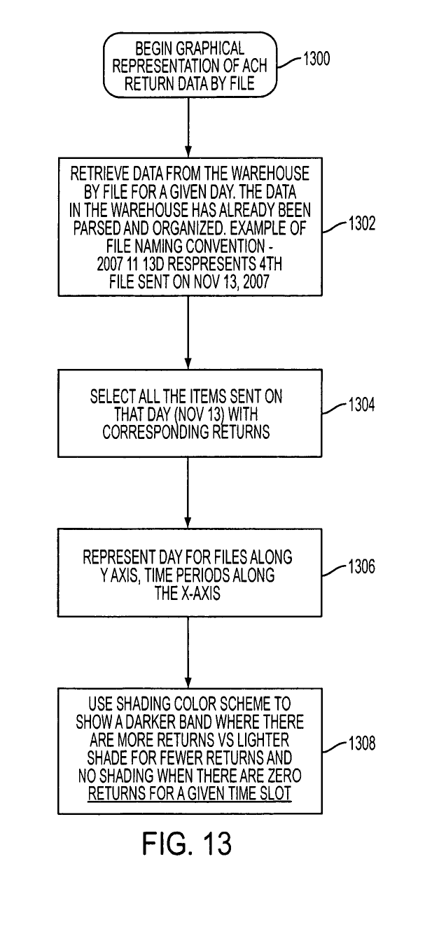

FIG. 13 shows an exemplary method 1300 for creating the return age by file chart, such as the chart shown in FIG. 12. The method 1300 generates a graphical representation of ACH return data by file by retrieving data from the warehouse by file for a given day (step 1302). The data in the warehouse has already been parsed and organized, as described above with respect to FIG. 7. An example of a file naming convention is 2007 11 13D, which represents the fourth file sent on Nov. 13, 2007. The method 1300 continues by selecting all of the items sent on that day (Nov. 13, 2007) with corresponding returns (step 1304). A chart, such as the chart shown in FIG. 12 may be created by representing the day for the files along the y-axis and the time periods along the x-axis (step 1306). A shading color scheme may be used to show a darker band where there are more returns, a lighter shade where there are fewer returns, and no shading where there are zero returns for a given time slot, such as day 25. In FIG. 12, the returns on day 25 were numerous, hence the darker shading.

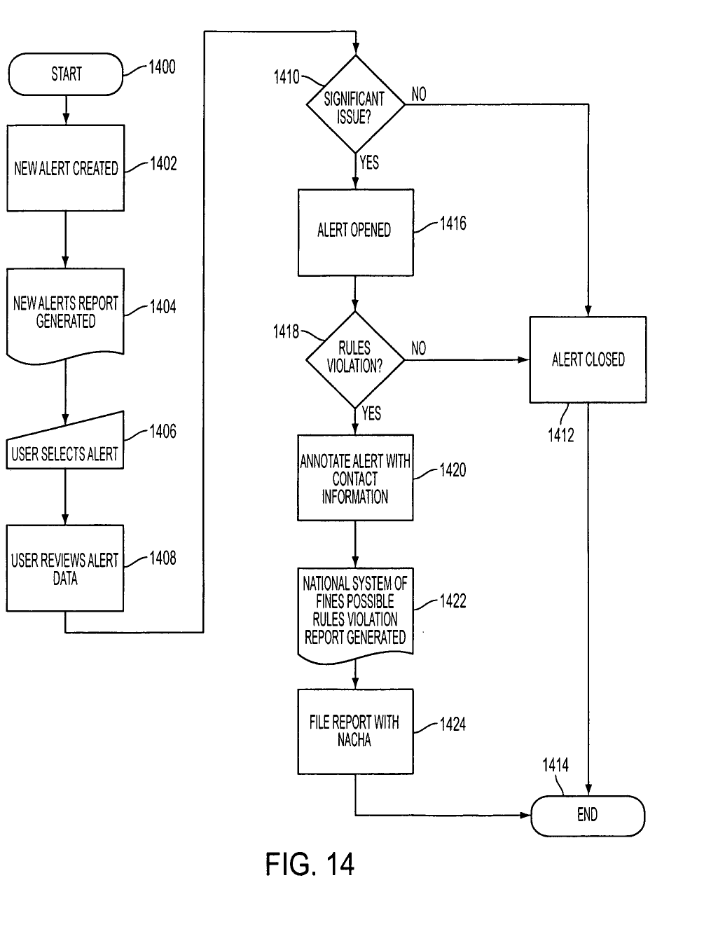

FIG. 14 shows an exemplary method 1400 for handling rules violations. The method 1400 may include creating a new alert 1402, generating a new alerts report 1404, and user selection of an alert 1406 and user review of alert data 1408. If there are no significant issues 1410, the alert may be closed 1402 and the method may end 1414. Otherwise, if there are any significant issues 1410, the alert may be opened 1416. If there is a significant issue but no rules violation 1418, then the alert may be closed 1412; otherwise, the alert may be annotated with contact information 1420 and a rules violation report may be generated 1422 and filed with NACHA 1424. Violations of NACHA networks rules are prosecuted through the National System of Fines. In order to begin the process, the reporting party (typically the RDFI) currently makes a submission to NACHA using an intimidating form that requires the assembly of a host of data that is often difficult to track down. Experience indicates that most DFIs fail to report detection of possible rules violations due to the difficulty of completing the form and gathering the required supporting data. The method 1400 automates, in whole or in part, this process of collecting the required data and producing a completed form ready for submission to NACHA.

An exemplary embodiment of the automated clearing house analysis and processing system may include a system hardware and software architecture environment which may use any of various well known architectures. In one exemplary embodiment, a software service may be offered as a service oriented architecture (SOA). According to another exemplary embodiment, the software processing system may be offered as an exemplary application service provider (ASP) based offering. In another exemplary embodiment, an exemplary client server architecture may be provided. In still other exemplary embodiments, the ACH processing system may be provided as a service over a network, whether in a client-server architecture, or any other well know network design, architecture and/or topology such as, e.g., but not limited to, peer-to-peer, hierarchical, standalone, distributed enterprise, etc. may also be used. In one exemplary embodiment, the ACH processing system, may be offered as a software as a service (SaaS) offering.

FIG. 15 depicts diagram 1500 illustrating an exemplary computer system such as may be used in devices that may be used in implementing an exemplary embodiment of the present invention. Specifically, FIG. 15 depicts an exemplary embodiment of a computer system 1500 that may be used in computing devices such as, e.g., but not limited to, a client and/or a server, etc., according to an exemplary embodiment of the present invention. FIG. 15 depicts an exemplary embodiment of a computer system that may be used as the devices, web server, application device/platforms, etc. The present invention (or any part(s) or function(s) thereof) may be implemented using hardware, software, firmware, and/or a combination thereof and may be implemented in one or more computer systems or other processing systems. In fact, in one exemplary embodiment, the invention may be directed toward one or more computer systems capable of carrying out the functionality described herein. An example of a computer system 1500 is shown in FIG. 15, depicting an exemplary embodiment of a block diagram of an exemplary computer system useful for implementing the present invention. Specifically, FIG. 15 illustrates an example computer 1500, which in an exemplary embodiment may be, e.g., but not limited to, a personal computer (PC) system running an operating system such as, e.g., (but not limited to) MICROSOFT® WINDOWS® NT/98/2000/XP/CE/MEBVISTA/etc. available from MICROSOFT® Corporation of Redmond, Wash., U.S.A. However, the invention may not be limited to these platforms. Instead, the invention may be implemented on any appropriate computer system running any appropriate operating system such as, e.g., but not limited to, an Apple computer executing MAC OS, UNIX, Linux, etc. In one exemplary embodiment, the present invention may be implemented on a computer system operating as discussed herein. An exemplary computer system, computer 1500 is shown in FIG. 15. Other exemplary computer systems may contain additional components, such as, e.g., but not limited to, a computing device, a communications device, mobile phone, a telephony device, an iPhone (available from Apple of Cupertino, Calif. USA), a 3G wireless device, a wireless device, a telephone, a personal digital assistant (PDA), a personal computer (PC), a handheld device, a portable device, an interactive television device (iTV), a digital video recorder (DVD), client workstations, thin clients, thick clients, fat clients, proxy servers, network communication servers, remote access devices, client computers, server computers, peer-to-peer devices, routers, gateways, web servers, data, media, audio, video, telephony or streaming technology servers, game consoles, content delivery systems, etc., may also be implemented using a computer such as that shown in FIG. 15. In an exemplary embodiment, services may be provided on demand using, e.g., but not limited to, an interactive television device (iTV), a video on demand system (VOD), via a digital video recorder (DVR), and/or other on demand viewing system.

The computer system 1500 may include one or more processors, such as, e.g., but not limited to, processor(s) 1504. The processor(s) 1504 may be coupled to and/or connected to a communication infrastructure 1506 (e.g., but not limited to, a communications bus, cross-over bar, backplane, backbone, planar, motherboard, or network, etc.). Various exemplary embodiments may be described in terms of this exemplary computer system. After reading this description, it may become apparent to a person skilled in the relevant art(s) how to implement the invention using other computer systems and/or architectures.

Computer system 1500 may include a display interface 1531 that may forward, e.g., but not limited to, graphics, text, and other data, etc., from the communication infrastructure 1506 (or from a frame buffer, etc., not shown) for display on the display unit 1530.

The computer system 1500 may also include, e.g., but may not be limited to, a main memory 1508, random access memory (RAM), and a secondary memory 1510, etc. The secondary memory 1510 may include, e.g., but not limited to, a computer readable medium such as, for example, (but not limited to) a storage device, a hard disk drive 1512 and/or a removable storage drive 1514, representing a floppy diskette drive, a magnetic tape drive, an optical disk drive, magneto-optical (MO) device, a flash memory device, universal serial bus (USB) storage device, a compact disk (CD) drive CD-ROM, a digital versatile disk (DVD), etc. The removable storage drive 1514 may, e.g., but not limited to, read from and/or write to a removable storage unit 1518 in a well known manner. Removable storage unit 1518, also called a program storage device or a computer program product, may represent, e.g., but not limited to, a floppy disk, magnetic tape, optical disk, compact disk, DVD, CD, MO, USB device, flash memory device, etc. which may be read from and written to by removable storage drive 1514. As may be appreciated, the removable storage unit 1518 may include a computer usable storage medium having stored therein computer software and/or data. In some exemplary embodiments, a “machine-accessible medium” may refer to any storage device used for storing data accessible by a computer. Examples of a machine-accessible medium may include, e.g., but not limited to: a magnetic hard disk; a floppy disk; an optical disk, a compact disk read-only memory (CD-ROM), a write once read many (WORM) device, a magneto-optical (MO) device, a read write (R/W) device, flash memory, non-volatile memory, or a digital versatile disk (DVD), DVD-R, DVD-RW, digital video recorder disk (DVR), a magnetic tape, and a memory chip, etc.

In alternative exemplary embodiments, secondary memory 1510 may include other similar devices for allowing computer programs or other instructions to be loaded into computer system 1500. Such devices may include, for example, a removable storage unit 1522 and an interface 1520. Examples of such may include a program cartridge and cartridge interface (such as, e.g., but not limited to, those found in video game devices), a removable memory chip (such as, e.g., but not limited to, an erasable programmable read only memory (EPROM), or programmable read only memory (PROM) and associated socket, and other removable storage units 1522 and interfaces 1520, which may allow software and data to be transferred from the removable storage unit 1522 to computer system 1500.

Computer 1500 may also include an input device such as, e.g., (but not limited to) a mouse 1506 or other pointing device such as a digitizer, an audio capture device 1528 (such as, e.g., but not limited to, a microphone), an image video/visual capture device 1532 (such as, e.g., but not limited to, a camera), and a keyboard 1505 and/or other data entry device (not shown), etc.

Computer 1500 may also include output devices, such as, e.g., (but not limited to) display 1530, display interface 1531, and/or a speaker 1507, etc. Other output devices may also be used, including, e.g., but not limited to, a printer, etc. Computer 1500 may include input/output (I/O) devices such as, e.g., (but not limited to) communications interface 1524 and communications path 1526, etc. These devices may include, e.g., but not limited to, a network interface card 1502, and modem(s) 1503. Communications interface 1574 may allow software and data to be transferred between computer system 1500 and external devices.

In this document, the terms “computer program medium” and “computer readable medium” may be used to generally refer to. media such as, e.g., but not limited to removable storage drive 1514, a hard disk installed in hard disk drive 1512, a storage area network (SAN), database, etc. These computer program products may provide software to computer system 1500. The invention may be directed to such computer program products. In some cases, a computer program product may include software which may be distributed via a communication system and then may be stored on a storage device.

According to an exemplary embodiment, the system may be represented by a client-server network design or topology where the devices may be coupled, via, e.g., but not limited to, one or more web server device(s), one or more load balancing devices and/or one or more firewall(s), as well as a communications network (such as, e.g., a network, or the Internet), to the devices. Devices may include, according to an exemplary embodiment, client devices, server devices, etc. Devices may in some exemplary embodiments include a browser such as, e.g., but not limited to, Internet Explorer available from Microsoft Corporation of Redmond, Wash. Other browsers may include Mozilla, Netscape Navigator, Mozilla Firefox, Safari, Konqueror, Opera, Flock, Internet Explorer, Epiphany, K-Meleon, AOL Explorer, etc. which may in certain exemplary embodiments interact with a server application, or other application, as well as, may interpret code, tags, such as, e.g., but not limited to, hypertext markup language (HTML), extensible markup language (XML), Flash etc. Devices may be coupled to one or more exemplary storage media 402 such as, e.g., but not limited to, a computer readable medium, such as, e.g. but not limited to, a storage, a memory, a flash memory, a fileserver, a storage area network (SAN), a compact disc read only memory (CD-ROM), and/or a digital versatile disk (DVD), etc.

According to another exemplary embodiment (not shown), the devices could be represented by any of a number of well-known hardware network architectures and/or topologies including, but not limited to, a peer-to-peer network design, a client-server based architecture, an application services (ASP) based offering, a software as a service (SaaS) by which notification and/or informational content may be distributed from one computing device to another. Any other hardware architecture such as, e.g., but not limited to, a services oriented architecture (SOA), according to an exemplary embodiment of the present invention.

In an exemplary embodiment, an end user such as, e.g., but not limited to, a customer, a client service representative, etc. may access an application via a client device, such as devices, which may provide an interface to the user such as, e.g., but not limited to, a graphical user interface (GUI), which may execute on the device via, e.g., but not limited to, a client application or applet, which may, in an exemplary embodiment, include a browser-based application, or via another application, applet, or device (in the case of thin client devices).

The devices may be coupled to one another over a communications path such as, e.g., but not limited to, an intranet, the Internet or a network. The devices may be coupled to one another and may communicate via one or more applications which may include a browser such as, e.g., but not limited to, an internet browser, which may include, e.g., but not limited to, Microsoft Internet Explorer, Netscape Navigator, Mozilla, and FireFox, utilizing the standard Internet hypertext transfer protocol (“HTTP”), extensible markup language (XML), and universal resource locators (“URLs”). Although the use of HTTP may be described herein, any well known transport protocol may be used without deviating from the spirit or scope of the invention.

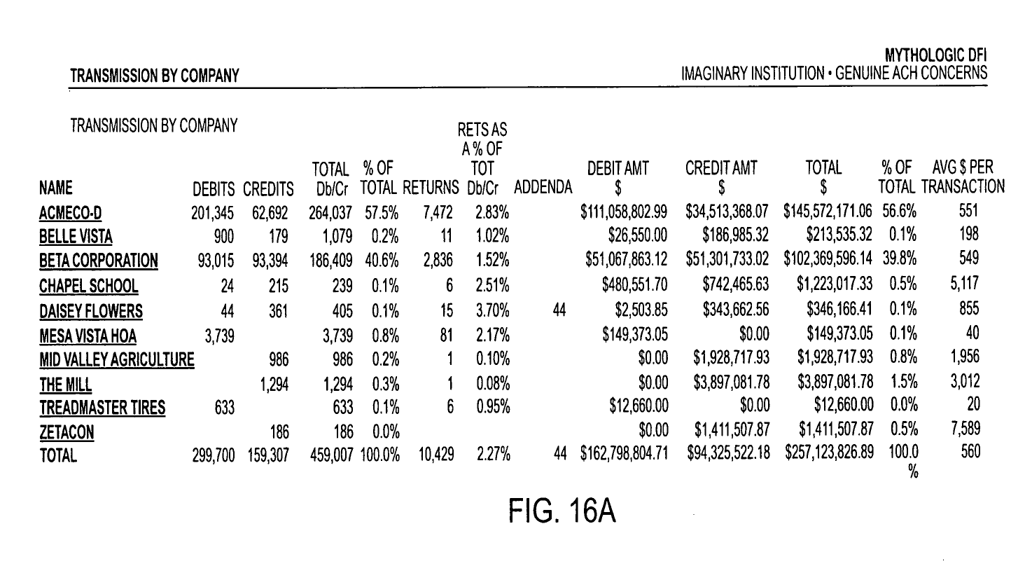

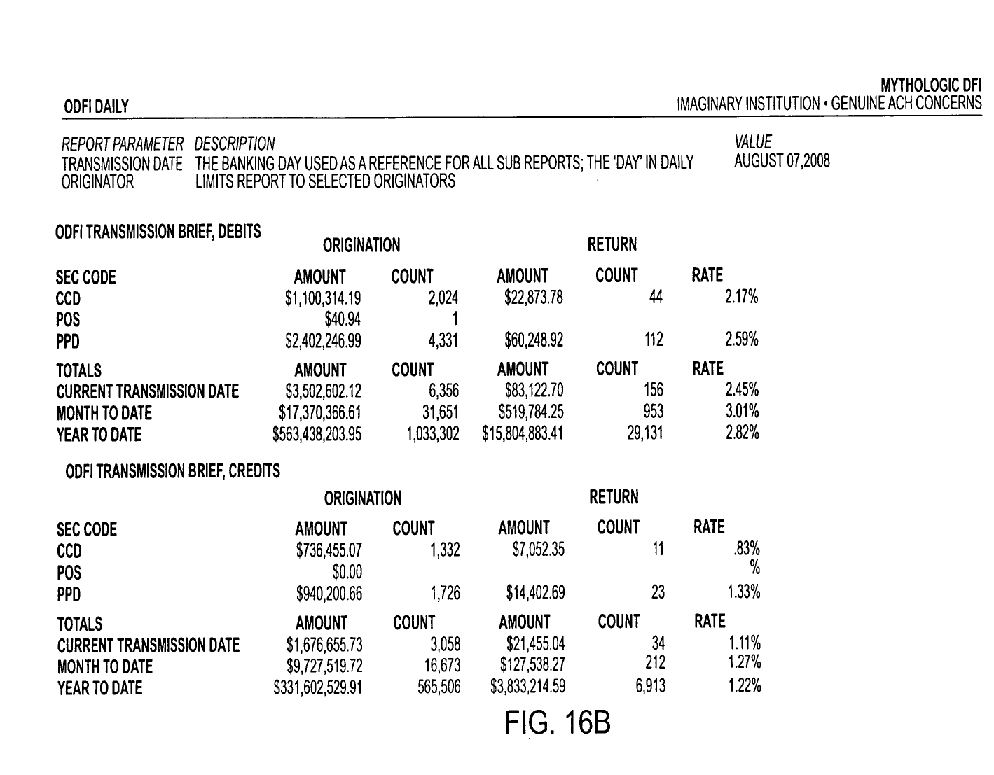

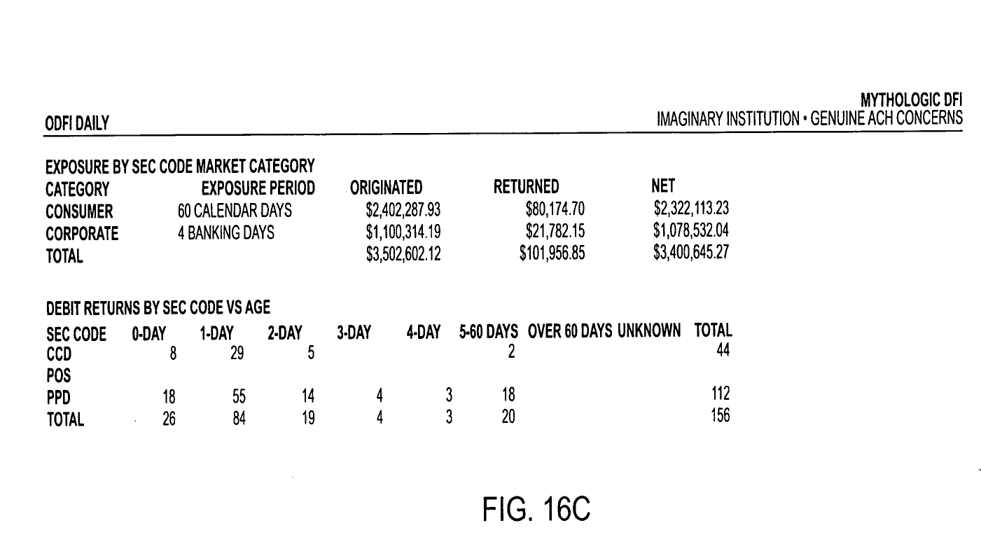

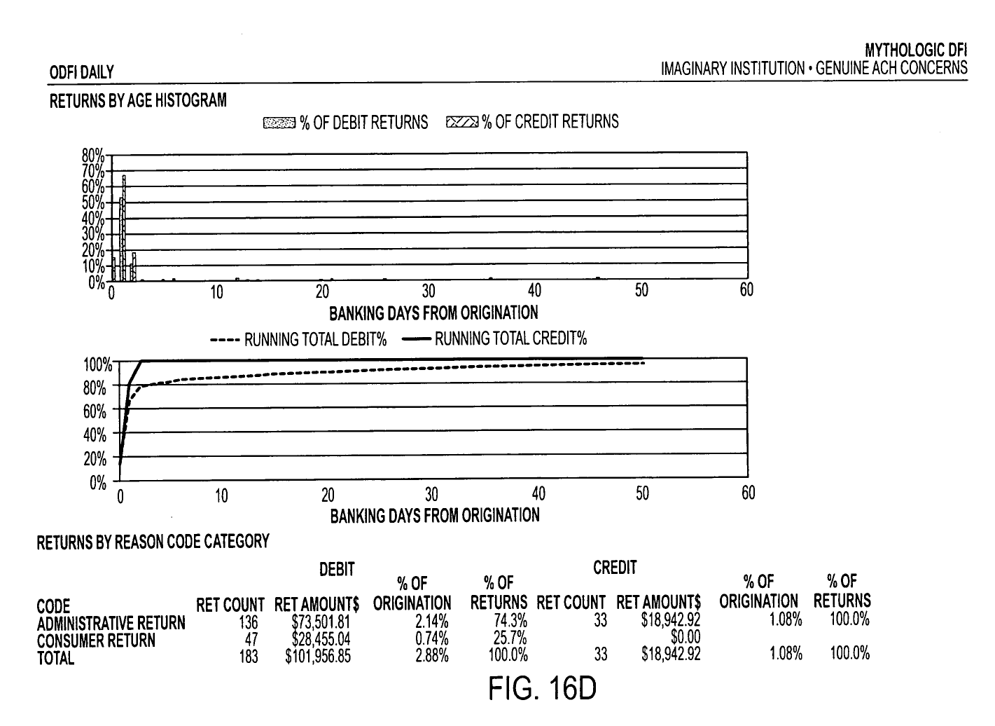

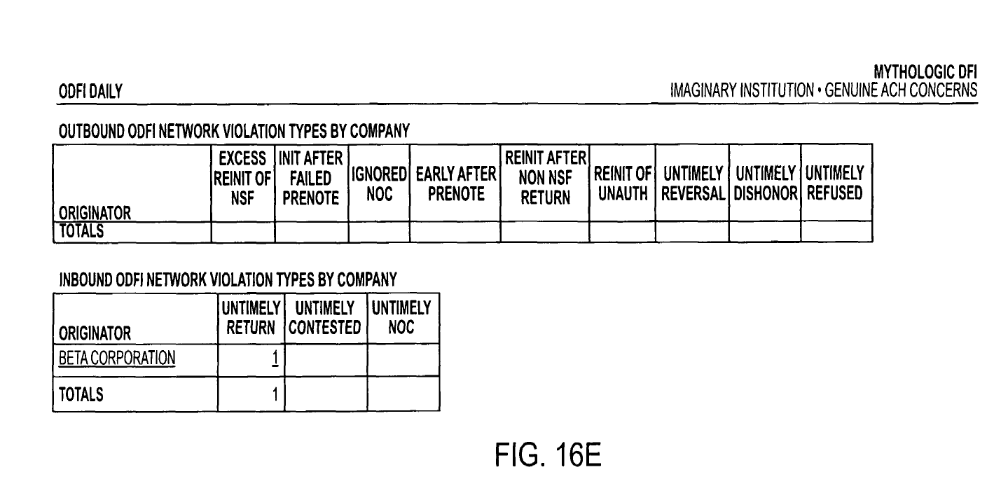

FIGS. 16A-16E illustrate some sample reports. FIG. 16A illustrates ODFI transaction volume transmission by company and FIGS. 16B-16E illustrate an ODFI daily report. The transmission by company report shows a table depicting returns by company. The daily report shows returns, including some returns represented graphically as a histogram.

While various embodiments of the present invention have been described above, it should be understood that they have been presented by way of example only, and not limitation. Thus, the breadth and scope of the present invention should not be limited by any of the above-described exemplary embodiments, but should instead be defined only in accordance with the following claims and their equivalents.

What is claimed is:

1. A method for processing automated clearing house (ACH) historical data, comprising:
storing ACH historical data in at least one storage device, the ACH historical data comprising ACH data from at least one depository financial institution (DFI) and ACH data from at least one ACH operator;
identifying at least two related ACH transactions in the ACH historical data with a reconciler component capable of executing on at least one processor coupled to the storage device;
calculating an ACH return exposure with a risk management component capable of executing on the processor; and
displaying the ACH return exposure on at least one display device coupled to the processor.

2. The method of claim 1, wherein storing ACH historical data comprises capturing ACH historical data from a DFI's native file system at various time intervals.

3. The method of claim 1, wherein storing ACH historical data comprises capturing DFI data from the ACH operator, storing and forwarding the ACH historical data to a concerned DFI at various time intervals.

4. The method of claim 1, wherein calculating the ACH return exposure is performed by using logic- and rule-based techniques.

5. The method of claim 1, further comprising securing the privacy of the ACH historical data.

6. The method of claim 1, further comprising using at least one data warehouse and at least one online analytical processing (OLAP) cube.

7. The method of claim 1, further comprising discovering and reporting rule violations.

8. The method of claim 1, further comprising discovering irregular item return activity.

9. The method of claim 1, wherein displaying the ACH return exposure comprises at least one report in columnar and graphical representations.

10. The method of claim 1, wherein calculating the ACH return exposure comprises using weighted return rates.

11. The method of claim 10, wherein the weighted return rates are weighted based on previous originations.

12. The method of claim 10, wherein the weighted return rates are weighted based on return aging.

13. The method of claim 1, wherein displaying the ACH return exposure comprises a visualization of a basis for the ACH return exposure.

14. The method of claim 13, wherein the visualization comprises a two-dimensional gray-scale plot.

15. The method of claim 13, wherein one of the two dimensions is an x-axis representing future time.

16. The method of claim 13, wherein one of the two dimensions is a y-axis representing origination files.

17. The method of claim 1, wherein the reconciler component identifies related ACH transactions in the ACH historical data by using a plurality of hashed surrogate keys.

18. The method of claim 17, wherein the hashed surrogate keys are derived from item attributes.

19. The method of claim 17, wherein the ACH transactions are partitioned by time.

20. The method of claim 17, wherein the ACH transactions are partitioned by value.

21. The method of claim 1, further comprising identifying at least one rules violation.

22. The method of claim 21, wherein at least one potential rules violation is described by at least one database that stores patterns.

23. The method of claim 22, wherein the rules violations are detected by comparing a plurality of token sentences to the database of potential rules violation patterns.

24. The method of claim 1, further comprising identifying at least one exception.

25. The method of claim 24, further comprising reporting the exception by following a new, open, or-closed workflow.

26. The method of claim 25, wherein the exception comprises at least one rules violation.

27. The method of claim 25, wherein the exception comprises at least one potential risk event.

28. A method for processing automated clearing house (ACH) historical data, comprising:
storing ACH historical data in at least one storage device, the ACH historical data comprising ACH data from at least one depository financial institution (DFI) and ACH data from at least one ACH operator;
identifying at least two related ACH transactions in the ACH historical data with a reconciler component capable of executing on at least one processor coupled to the storage device;
detecting at least one ACH rules violation with a pattern matching component capable of executing on the processor; and
providing at least one alert for the detected ACH rule violation through at least one messaging system coupled to the processor.

29. A computer program product stored on a storage medium, the computer program product comprising instructions for performing a method for processing automated clearing house (ACH) historical data, the method comprising:
storing ACH historical data in at least one storage device, the ACH historical data comprising ACH data from at least one depository financial institution (DFI) and ACH data from at least one ACH operator;
identifying at least two related ACH transactions in the ACH historical data with a reconciler component capable of executing on at least one processor coupled to the storage device;
calculating an ACH return exposure with a risk management component capable of executing on the processor; and
displaying the ACH return exposure on at least one display device coupled to the processor.
